(19) United States
(12) Patent Application Publication
(10) Pub. No.: US 2002/0191244 A1
(43) Pub. Date: Dec. 19, 2002

(54) Disjoint shared protection

(76) Inventors: Roman Antosik, Colts Neck, NJ (US); Raj Acharya, Ocean, NJ (US); Kevin Beach, Old Bridge, NJ (US); Jayanta Das, Morganville, NJ (US); Bharat Dave, Howell, NJ (US); Frank Hujber, Mercerville, NJ (US); Scott Kaminski, Highlands, NJ (US); Kuo-Ming Lee, Morganville, NJ (US); Robin Paul, Ocean, NJ (US); Jithamithra Sarathy, Atlantic Highlands, NJ (US); Ronald Simprini, Red Bank, NJ (US); Boris Stefanov, Gillette, NJ (US)

Correspondence Address: KAPLAN & GILMAN , L.L.P., 900NROUTE 9 NORTH, WOODBRIDGE, NJ, 07095, US

(21) Appl. No.: 10/118,595

(22) Filed: Apr. 8, 2002

Related U.S. Application Data
(60) Provisional application No. 60/282,075, filed on Apr. 6, 2001.
(60) Provisional application No. 60/282,072, filed on Apr. 6, 2001.

(51) Int. Cl. H04B 10/08; H04B 10/20; H04J 14/00

(52) U.S. Cl. 359/110; 359/118

(57) ABSTRACT

A method and apparatus for providing signaling for disjoint shared protection in a data network are presented. In a preferred embodiment the method utilizes one or more of the same set of finite optical signals used for maintenance purposes in the network, which can be recognized without regard to bit rate or format. Nodes that share a failed link send an alarm signal that reaches the initiator and terminator node, whereupon the initiator node sends a signal that activates a protection lightpath. When the signal sent by the initiator node arrives at the terminator node, it sends back an acknowledge signal. If the acknowledge signal is not received within a certain time protection is voided. Contention for shared protection resources is resolved via a priority scheme.

### CROSS REFERENCE TO OTHER APPLICATIONS

This application claims the benefit of each of U.S. Provisional Patent Application Serial No. 60/282,075, filed on Apr. 6, 2001, and U.S. Provisional Patent Application Serial No. 60/282,072, also filed on Apr. 6, 2001.

### TECHNICAL FIELD

This invention relates to optical communications, and in particular to a method of shared protection of lightpaths in a data network.

### BACKGROUND OF THE INVENTION

Optical fiber networks are in widespread use due to their ability to support high bandwidth connections. The bandwidth of optical fibers runs into gigabits and even terabits. Optical links can thus carry hundreds of thousands of communications channels multiplexed together.

One of the fundamental requirements of nodal network elements in optical networks is the capability to signal other nodal elements as to the occurrence of faults and failures. Presently, this is achieved by converting the incoming optical signal into an electrical signal followed reading various format dependent bits. All optical networks require maintenance signaling without resorting to Optical-to-Electrical, or O-E-O, conversion of the signal. In response to such faults or failures, optical data networks utilize protection schemes. Such schemes, to efficiently allocate protection resources, often implement shared protection.

The future of optical networks lies in optical transparency, where the nodal devices in the optical network must work with any commercially desired line rate, independent of format, whatever that is or that may be. If protection signaling is done by using a prescribed set of bits in a prescribed location in a data packet, which then must be read by a network node, such signaling cannot be used for a format and bit rate transparent network. Thus, one of the fundamental future network elements must provide is the capability to implement wholly optical maintenance signaling in such an environment.

What is therefore needed is an all-optical maintenance signaling system that requires neither OEO conversion nor requires the network nodes to read/decode bits to convey maintenance information throughout a data network.

### SUMMARY OF THE INVENTION

A method and apparatus for providing signaling for disjoint shared protection in a data network are presented. In a preferred embodiment the method utilizes one or more of the same set of finite optical signals used for maintenance purposes in the network, which can be recognized without regard to bit rate or format. Nodes that share a failed link send an alarm signal that reaches the initiator and terminator node, whereupon the initiator node sends a signal that activates a protection lightpath. When the signal sent by the initiator node arrives at the terminator node, it sends back an acknowledge signal. If the acknowledge signal is not received within a certain time protection is voided. Contention for shared protection resources is resolved via a priority scheme.

### BRIEF DESCRIPTION OF THE DRAWINGS

FIG. 1 depicts an illustrative exemplary three node network;

FIG. 2 depicts shared protection of services with disjoint PRSS groups according to the present invention;

FIG. 3A depicts the switch fabric and an I/O port of an exemplary network node;

FIG. 3B depicts the three node network of FIG. 1 as configured just after failure detection according to the present invention;

FIG. 4 depicts the network of FIG. 3B with protection controls as triggered by the detected failure; and

FIG. 5 depicts the network of FIG. 3B with protection controls as triggered by an acknowledge message according to the present invention.

### DETAILED DESCRIPTION OF THE PREFERRED EMBODIMENTS

Before one or more embodiments of the invention are explained in detail, it is to be understood that the invention is not limited in its application to the details of construction or the arrangements of components set forth in the following description or illustrated in the drawings (the terms “construction” and “components” being understood in the most general sense and thus referring to and including, in appropriate contexts, methods, algorithms, processes and subprocesses). The invention is capable of other embodiments and of being practiced or being carried out in various ways. Also, it is to be understood that the phraseology and terminology used herein is for the purpose of description and should not be regarded as in any way limiting.

In order to simplify the discussion herein, certain terms of art will be used extensively. Such terms of art are defined below in the following Table A.

TABLE A
DEFINITION OF TERMS

| | |
|---|---|
| 1. | Disjoint shared protection - a protection with the protection meta- |
| | lightpath that has no common nodes and links with protection meta- |
| | lightpaths protecting services that are members of the PRSS group of |
| | the service lightpath it protects |
| 2. | Link - a pair of directly connected ports in two nodes. |
| 3. | Link shared-risk group (LSRG) - a list of link IDs of links failed by |
| | a single fiber cut |
| 4. | Link-risk-sharing services (LRSS) group - a list of lightpath IDs of |
| | services with service links in a given LSRG group. |
| 5. | Overbooking of a protection link - a provisioned maximum number of |
| | protection meta-lightpaths sharing one protection link |
| 6. | Path-risk-sharing services (PRSS) group - a union of all LRSS groups |
| | that a given service lightpath belongs to. |
| 7. | Protection link - a link reserved to provision protection meta-light- |
| | paths. |
| 8. | Protection meta-lightpath - an optical end-to-end path made of pro- |
| | tection links not cross-connected at provisioning. The path is |
| | cross-connected at the time of failure of the service lightpath |
| | it protects. |
| 9. | Protection-link-sharing protections (PLSP) group - a list of lightpath |
| | IDs of service lightpaths protected by protection meta-lightpaths |
| | sharing given protection link |
| 10. | Roll - a bi-directional switch of the client signal to/from the pro- |
| | tection meta-lightpath |
| 11. | Service lightpath - an end-to-end optical path made of service links |
| | cross-connected at provisioning |
| 12. | Service link - a link in a service lightpath |

Optical networks protect customer traffic against network failures. The speed of protection must be at least as that of the SONET ring networks: 60 mseconds for single failures (span protection) and 200 mseconds for multiple failures (ring protection). SONET rings require 50% of transmission capacity to be dedicated for protection. The challenge is to design an optical network protecting failures as fast as SONET but with less than 50% capacity reserved for protection. Dynamic end-to-end mesh restoration searches for alternate routes for the failed service lightpaths at the time of failure. This makes it much slower than the SONET restoration. Local mesh restoration is faster but gives limited choice of diverse alternate routes and thus requires more capacity to be reserved for protection. To avoid the slow search for an alternate protection lightpath this patent proposes specifying protection meta-lightpaths at provisioning. At the time of failure the protection meta-lightpaths are cross-connected with at least the speed of SONET protection. The present invention proposes an end-to-end implementation of the design, but the same design could be used by the region-by-region protection where a service lightpath is locally protected by protection regions each one with a local protection meta-lightpath. The present invention describes a disjoint protection scheme that protects 100% of service lightpaths failed by a single fiber cut. Sharing of protection results in contention for shared protection links when protecting more than one fiber cut. The design proposes a simple way to resolve the contention with the assigned priority of protection. Sharing of protection resources results in less than 100% protection of service lightpaths failed with two independent fiber-cuts.

### Shared Protection

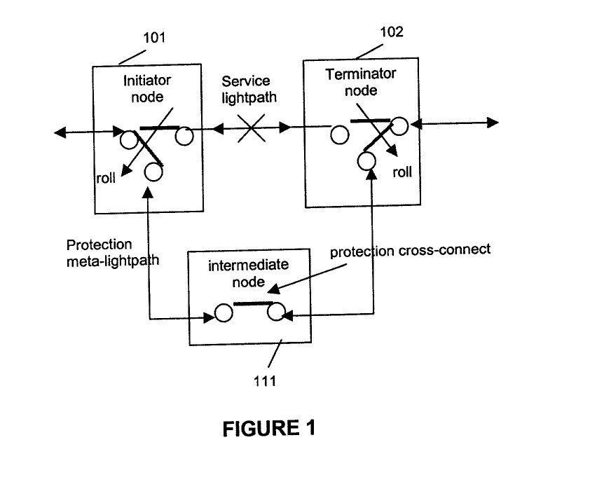

A provisioned end-to-end service lightpath is share-protected with a protection meta-lightpath. Service links of the service lightpath are cross-connected at provisioning. Protection links of the protection meta-lightpath are cross-connected at the time of failure. FIG. 1 shows an example of a three node network with provisioned end-to-end service lightpath protected by a protection meta-lightpath.

In FIG. 1 the bi-directional service lightpath and a corresponding protection meta-lightpath are provisioned from the initiator node 101 to the terminator node 102. The initiator node is provisioned to trigger bi-directional protection when it detects a failure.

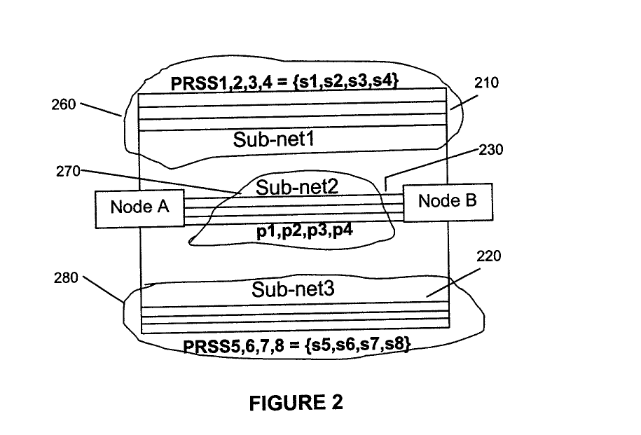

A shared-risk link group (SRLG) is a group of links failed with a single fiber cut. Service lightpaths provisioned with the links from the same SRLG group form a group of link-risk-sharing services (LRSS). The LRSS groups are updated each time one provisions or clears service links. Protection meta-lightpaths protecting services from the same LRSS group must be node and link diverse to protect their simultaneous failure with a fiber cut. A service lightpath is characterized by the path-risk-sharing services (PRSS) group—a union of all LRSS groups the lightpath is a member of. A “sufficient” condition for 100% protection is that protection meta-lightpaths protecting a PRSS group of services are node and link disjoint. Such protection is called a disjoint protection. The condition is not “necessary” which means that it is not an optimum implementation of 100% protection—the longer the service lightpaths the less optimum the implementation. This implementation, however, is much simpler than the implementation of the LRSS-disjointness. In local mesh restoration implementation of the “PRSS disjointness” approaches efficiency of the “LRSS disjointness”. FIG. 2 gives example of the PRSS group {s1,s2,s3,s4} common for s1,s2,s3,s4 services and the PRSS group {s5,s6,s7,s8} common for s5,s6,s7,s8 services. The groups are provisioned in node and link disjoint sub-nets 1 260 and 3 280. They can share protection links in sub-net2 270 node and link disjoint with sub-nets 1 260 and 3 280. For example service lightpaths s1 210 and s5 220 could be protected by the protection meta-lightpath p1 230.

Sharing of protection links by protection of disjoint PRSS groups gives 100% protection of all service lightpaths failed by a single fiber cut. Simultaneous failures of two disjoint PRSS groups sharing protection links leads to contention for the shared protection links. Each service lightpath is assigned a protection priority. Service lightpath with higher priority wins contention for shared protection link resources. A node that resolves the contention sends a FAILED-PROTECTION message to the initiator node of the service lightpath with the lower protection priority to inform it of the failure to protect the failed service.

### Provisioning of Shared-protected Services

The user reserves shared protection links with the overbooking parameter. The protection links are used to provision protection meta-lightpaths. The overbooking parameter specifies how many different protection meta-lightpaths can share one protection link. The user provisions a service lightpath and a corresponding disjoint protection meta-lightpath by specifying:

ID of the first node

ID of the port in the first node

ID of the second node

ID of the port in the second node

List of nodes and service links included in the service lightpath

List of nodes and protection links included in the protection meta-lightpath

List of nodes and service links excluded from the service lightpath

List of nodes and protection links excluded from the protection meta-lightpath

Methods to implement such provisioning are known to those skilled in the art.

Provisioning of the service lightpath identifies the PRSS group (union of the LRSS groups). Provisioning of the protection meta-lightpath uses the PRSS group to provision disjoint protection meta-lightpath that protection links characterized by the PLSP groups disjoint with the PRSS group. Provisioning of the protection meta-lightpath saves the protection cross-connects between the protection links in the local databases. The cross-connects are executed at the time of failure.

### Shared Protection of a Failed Service

The initiator 101 and the terminator 102 nodes (FIG. 1) detect failures of the service lightpath or a maintenance signal from an up-stream node detecting the failure. The initiator node performs roll to the protection meta-lightpath and triggers protection by sending a FAILED message with the lightpath ID and protection priority of the failed service along the protection meta-lightpath. The FAILED message cross-connects the protection links with the stored protection cross-connects. Terminator node receives the FAILED message and performs roll to the protection meta-lightpath. It responds with the ACKNOWLEDGE message along the cross-connected protection meta-lightpath. The ACKNOWLEDGE message locks the protection. Locking of a cross-connected protection meta-lightpath disables sharing of its links for the duration of protection. The initiator node receives the ACKNOWLEDGE message and successfully completes the protection. No arrival of the ACKNOWLEDGE message in a specified time indicates a failure of protection. In some implementations it is not possible to terminate the FAILED and the ACKNOWLEDGE messages of the failed services that lose competition for shared protection links. In this case a FAILED-PROTECTION message received by the initiator node identifies failed protection. The message could arrive prior to or after arrival of the ACKNOWLEDGE message.

In the event of multiple failures, contention for shared protection resources is resolved via a priority scheme, hence the transmission of a protection priority of the failed service lightpath with the FAILED message sent by the initiator node. In general the FAILED and ACKNOWLEDGE messages need not be optically transparent, inasmuch as they must encode relatively complicated information, such as lightpath ID and the protection priority of the failed lightpath. However, in alternative embodiments these messages will be optically transparent as well, using solely optical signaling methods, such as, for example, two or more optical frequencies as discrete optical symbols, defining a temporal symbol length, and thus encoding information such as lightpath ID and protection priority all optically. The use of the tunable laser will be advantageous to such embodiments, allowing one signal source to “write” or generate numerous optical “symbols” one after the other. At higher speeds, and thus smaller symbol time widths, two or more lasers could be used to generate the optical symbols with no retuning time delay. It is noted that this scheme is similar to an optical version of birdcalls, whose information content is a function of alternating pitch—or frequencies from a defined discrete set of such “allowed” frequencies—not achieved by encoding “bits” by modulating any of the utilized frequencies as a carrier wave.

### Implementation of Shared Protection

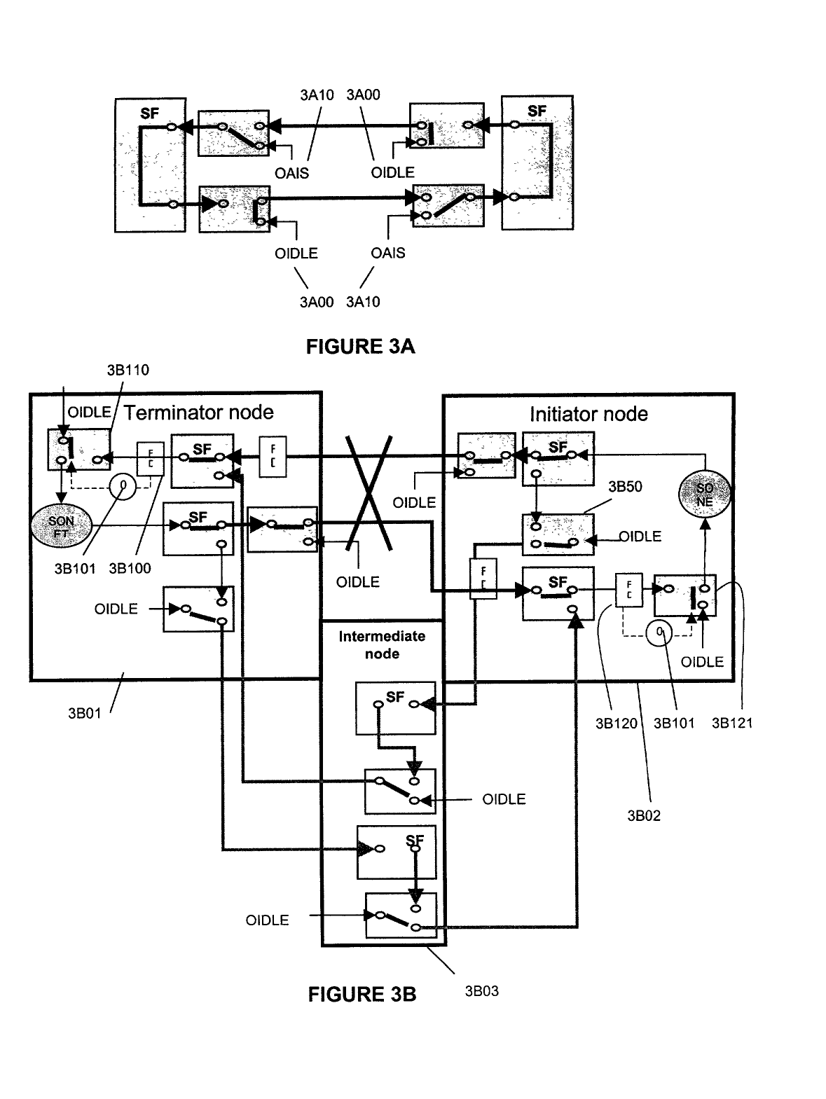

For illustration purposes, the invention will be described in terms of using one of two transparent (i.e., decoding bit rate and format are not necessary to decode the signals) maintenance signals, OAIS and OIDLE, Which are available in an exemplary optical data network. In the illustrated examples herein, the maintenance signal OIDLE will be used in protection signaling. FIG. 3A shows OIDLE and OAIS switch components of an I/O port in such an illustrative network. The OAIS switch is used to insert the OAIS maintenance signal and the OIDLE switch to insert the fill-up OIDLE signal. FIG. 3A shows normal mode of operation states of the protection link—an OIDLE signal 3A00 inserted to both directions of transmission to fill-up the protection link. As its name implies, the OIDLE signal is a filler or dummy signal. Note that the OAIS signal 3A10 is not inserted in either direction, inasmuch as no alarm triggering event has occurred; OAIS is a signal analogous to the SONET AIS signal, yet adapted to a transparent optical network, where no bits are read to decode it. In general it is recognized by optical parameters, such as frequency, polarization, both frequency and polarization, or the equivalent.

The OAIS switch in a protection link is not controlled during protection and will not be shown on the subsequent figures. In an alternative embodiment, the OAIS signal may be used as one of the optical “symbols” to encode information, and then will be utilized.

FIGS. 3B-5 depict an exemplary three node network (such as illustrated in FIG. 1) implementing the method of the invention. It is understood that this is a simplifying abstraction, for illustration purposes, from real optical data networks, whose nodes can number significantly, and whose protection pathways can be significantly complex.

FIG. 3B shows the three-node network from FIG. 1 with positions of the roll cross-connects and of the OIDLE switches just after a failure detection.

In FIG. 3B the failure detection module FD 3B100 detects a failure on the recieving side of a node. At the terminator node 3B01 failure detection module FD 3B100 controls the client-facing OIDLE switch 3B110 to insert as payload the OIDLE signal to suppress failure detection by the client terminal. This control signal is shown as control signal (0) 3B101. Similarly, at the initiator node 3B02, FD 3B120 causes OIDLE switch 3B121 to insert OIDLE towards the client side of the network. In these figures, client side of the network is illustrated by a “SONET” network, from which and to where the present invention's all optical data network receives and sends client data.

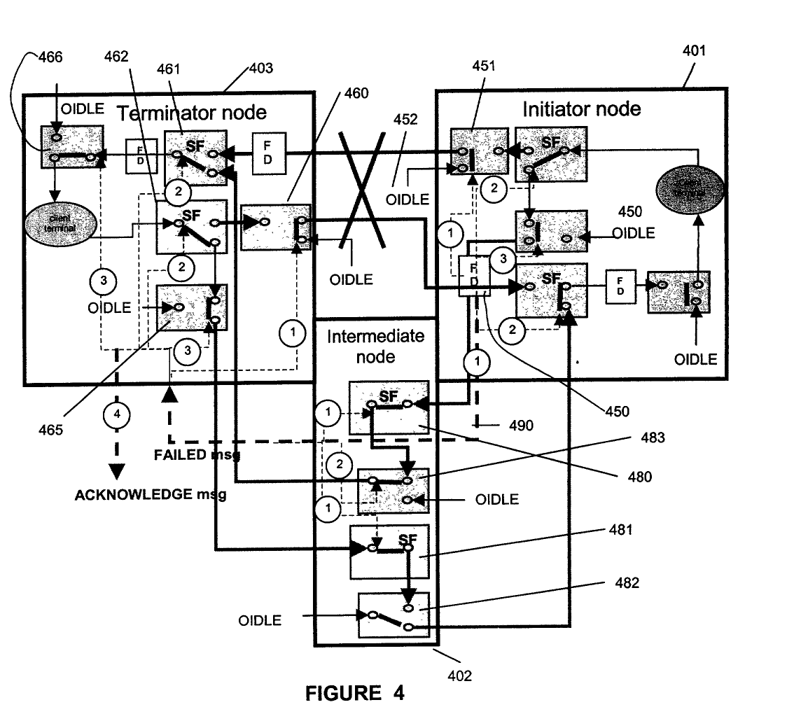

FIG. 4 depicts the protection controls triggered by a detected failure and the FAILED message. The following Table B describes the functionalities of such controls. Note that the circled numbers in the figure correspond to the numbers in the “Control” column of Table B.

TABLE B
Protection controls triggered by the detected failure and the FAILED message

| Node | Control | Description |
|---|---|---|
| Initiator | 1 | Control of service OIDLE switch to “insert OIDLE” |
| | 1 | Sending FAILED message to the terminator node |
| | 2 | Executed and completed bi-directional roll |
| | 3 | Control of protection OIDLE to “through” |
| Intermediate | 1 | Executed and completed bi-directional protection cross-connect |
| | 2 | Control of protection OIDLE switch to “through” |
| Terminator | 1 | Control of service OIDLE switch to “insert OIDLE” |
| | 2 | Executed and completed bi-directional roll |
| | 3 | Control of protection OIDLE switch to “through” |
| | 3 | Control of client-facing service OIDLE switch to “through” |
| | 4 | Sending ACKNOWLEDGE message to the initiator node |

With reference to FIG. 4, at the initiator node 401 the following control events occur. Failure Detection module 450 detects the failure on the receive side of the node. This causes the service OIDLE switch 451 to insert the OIDLE signal 452. At the same time a FAILED signal is sent to the terminator node 403 along path 490, which is a non-data path. Next a bi-directional roll to the protection lightpath through the intermediate node 402 is executed. Finally, the protection OIDLE signal which was set to insert OIDLE 450 (see FIG. 3 3B50) is now set to “through”, allowing the client data to flow through the protection OIDLE switch to intermediate node 402.

At the intermediate node 402, the protection cross connect is executed, switching initiator traffic through switch 480, and terminator node traffic through switch 481. At this point however, the intermediate node protection OIDLE switch 482 is still feeding an OIDLE signal to the initiator node in the reverse direction (i.e., to the initiator node). Next the forward direction (defined here for illustration purposes as initiator to terminator) protection OIDLE switch 483 is set to “through.”

Finally, at the terminator node, the service OIDLE switch 460 is set to “insert OIDLE”, switch fabric switches 461 and 462 perform a bi-directional roll to the protection lightpath, and the protection OIDLE switch 465 and the client facing service OIDLE switch 466 are set to “through”, the latter action reversing control (0) of FIG. 3 as to the terminator node (but not yet as to the initiator node).

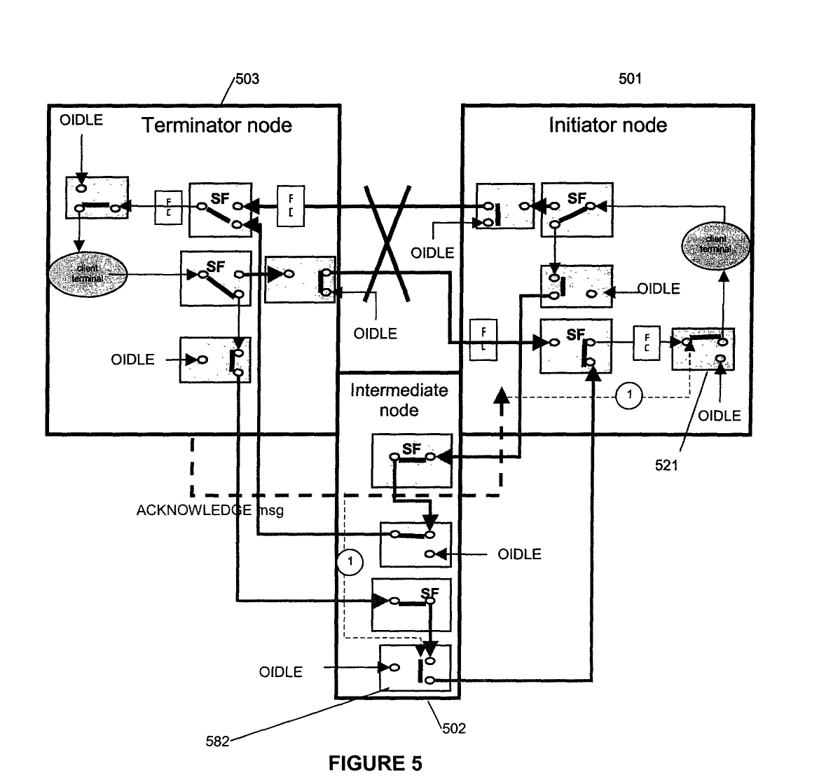

Lastly, the terminator node sends an ACKNOWLEDGE to the initiator node, the effect of which is shown in FIG. 5.

FIG. 5 depicts the protection controls triggered by an ACKNOWLEDGE message. Table C describes the functionalities of the corresponding controls.

TABLE C
Protection controls triggered by the ACKNOWLEDGE message

| Node | Control | Description |
|---|---|---|
| Intermediate | 1 | Control of protection OIDLE switch from “insert OIDLE” to through |
| Initiator | 1 | Control of client-facing service OIDLE switch to “through” |

The ACKNOWLEDGE being received at the initiator node 501 completes the lightpath (using the protection path) in the reverse direction. Thus, at the initiator node the client-facing service OIDLE switch 521 is set to “through”, and at the intermediate node the protection OIDLE switch 582 is changed from “insert OIDLE” to through.

If the ACKNOWLEDGE message is not received at the initiator node 501 within a defined time, protection is not implemented.

While the above describes the preferred embodiments of the invention, various modifications or additions will be apparent to those of skill in the art. Such modifications and additions are intended to be covered by the following claims.

What is claimed:

1. A method of signaling for use in a disjoint shared protection system, comprising:
utilizing a finite set of optical signals, where such signals can be recognized in a manner that is format and bit rate transparent.

2. The method of claim 1, utilized in a data network with an initiator and a terminator node and at least one intermediate node, where:
nodes that share a failed link send an optical signal that reaches the initiator and terminator node;
the initiator node sends a signal that activates a protection lightpath;
when the signal sent by the initiator node arrives at the terminator node, it sends back an acknowledge signal; and
absence of receipt of the acknowledge signal within a defined time voids implementation of protection.

3. The method of claim 2, where contention for shared protection resources is resolved via a priority scheme.

4. The method of claim 1, where the finite set of optical signals belong to the same set used by the data network for maintenance signaling.

5. The method of claim 2, where the finite set of optical signals belong to the same set used by the data network for maintenance signaling.

6. The method of claim 3, where the finite set of optical signals belong to the same set used by the data network for maintenance signaling.

7. The method of claim 1, where contention for shared protection resources is resolved via a priority scheme.

8. The method of claim 2, where contention for shared protection resources is resolved via a priority scheme.

9. The method of claim 3, where contention for shared protection resources is resolved via a priority scheme.

10. The method of claim 4, where contention for shared protection resources is resolved via a priority scheme.

11. The method of claim 5, where contention for shared protection resources is resolved via a priority scheme.

12. The method of claim 6, where contention for shared protection resources is resolved via a priority scheme.
